(19) United States
(12) Patent Application Publication
(10) Pub. No.: US 2022/0206674 A1
(43) Pub. Date: Jun. 30, 2022

(54) SYSTEMS AND METHODS OF PERSONALIZED USER INTERACTION WITH DIGITAL CONTENT

(71) Applicant: True Ingenuity Ltd, Leicester (GB)

(72) Inventors: Jonathan David George Appleton, Leicestershire (GB); James Frederick Abraham, Leicestershire (GB)

(21) Appl. No.: 17/553,261

(22) Filed: Dec. 16, 2021

Related U.S. Application Data
(63) Continuation of application No. 17/095,140, filed on Nov. 11, 2020, now abandoned.

(51) Int. Cl. G06F 3/04842; G06F 16/95; G06F 3/04817

(52) U.S. Cl. CPC G06F 3/04842; G06F 3/04817; G06F 16/95

(57) ABSTRACT

A system is provided that allows users to interact with digital content using personalized interactions. The personalized interactions may be images (e.g., selfies) that are used in connection with providing feedback for digital content.

### PRIORITY APPLICATION

This application is a Continuation of U.S. application Ser. No. 17/095,140, filed Nov. 11, 2020, now pending; the contents of which is incorporated herein by reference.

### TECHNICAL OVERVIEW

The technology described herein relates to techniques that provide for new types of user interactions in an online, digital environment. More particularly, the technology described herein relates to allowing users to personalize their interactions with online digital content.

### INTRODUCTION

The Internet and other forms of electronic communication have brought vast changes in how individuals interact with one another. One of the common ways users interact is by using like/dislike actions, providing ratings, or other preset interactions to interact with various form of digital content. Facebook has likes, texts have emoji's, and travel agency sites may use ratings or stars. However, there is still further development needed in these areas in order to provide improvements to users and how they interact with digital content.

Accordingly, it will be appreciated that new and improved techniques, systems, and processes are continually sought after.

### SUMMARY

In certain example embodiments, a system is provided that allows users to interact with digital content using personalized interactions that may be, for example, images. Users can use their personalized images to rate or other give feedback for digital content. The personalized images can realized by using static or animated media (e.g., a selfie, a video clip, a photo, etc.). The interactions may be performed through an app/application, via a website, or generally by using a computing device.

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 is an architecture diagram of a system that allows users to provide personalized interactions with digital content according to certain example embodiments;

FIG. 2A illustrates different personalized user interactions that can be specified by a user according to certain example embodiments;

FIG. 2B illustrates a binary option for allowing a user to provide personalized user interactions according to certain example embodiments;

FIG. 3 shows an example graphical user interface for adding personalized content according to certain example embodiments;

FIG. 4 shows an example graphical user interface for allowing users to add images to the interface shown in FIG. 3;

FIG. 5 shows an example graphical user interface that allows users to use their personalized interactions in connection with creating posts and providing ratings according to certain example embodiments;

FIG. 6 shows another example graphical user interface that allows users to use their personalized interactions to rate digital content according to certain example embodiments;

FIGS. 7-9 show three flow charts for processes that may be performed using the system shown in FIG. 1; and

FIG. 10 shows an example computing device that may be used in some embodiments to implement features described herein.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

### Overview

In certain example embodiments, a system is provided that allows users to interact with digital content using personalized interactions. The personalized interactions may include personalized images, called “true emotion” images in certain instances herein, that allow a user to interact (e.g., emotionally) when rating, scoring, liking, disliking, or performing other interactions with digital content (e.g., a review, a post, a comment, providing feedback, using social media, etc.). For example, instead of providing a number to rate a product, the user may provide their personalized image that is used to rate the product. The user's emotion can be realized by using a static or animated media image (e.g., a selfie or other photo). Such interaction may be performed through an app/application, via a website, or generally by using a computing device.

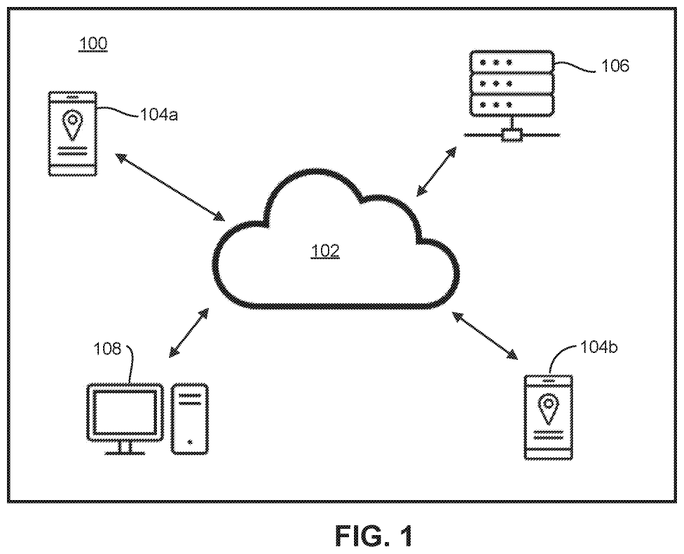

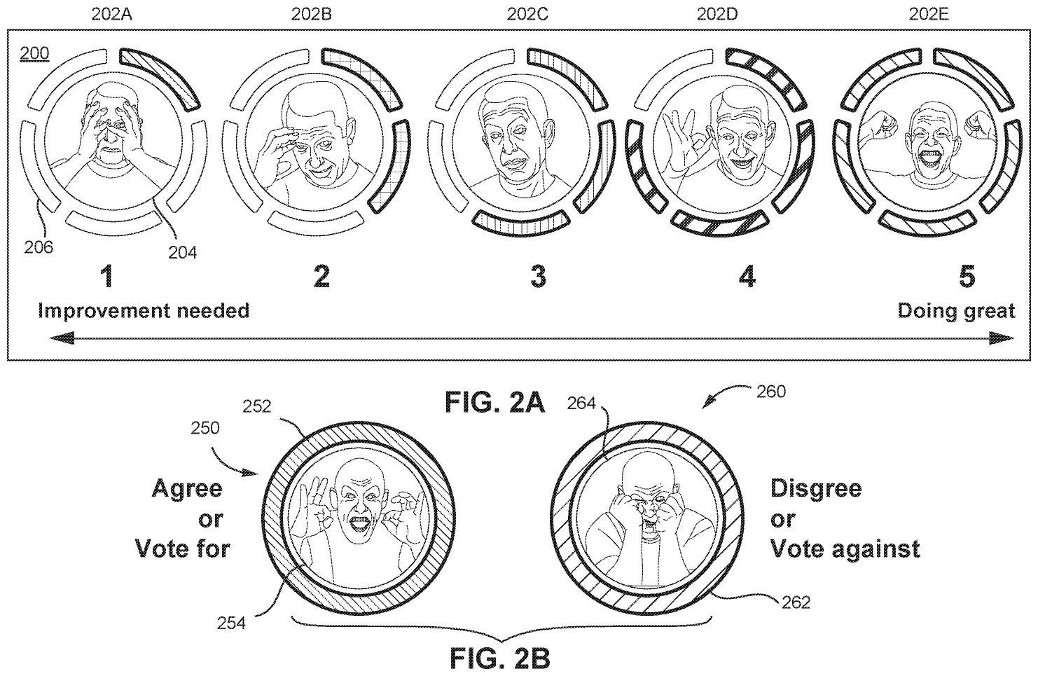

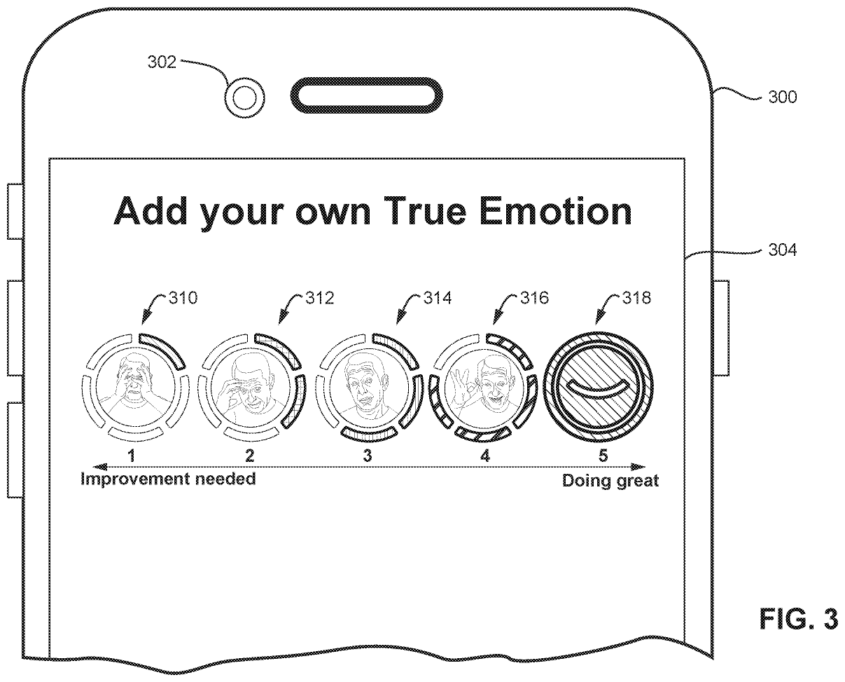

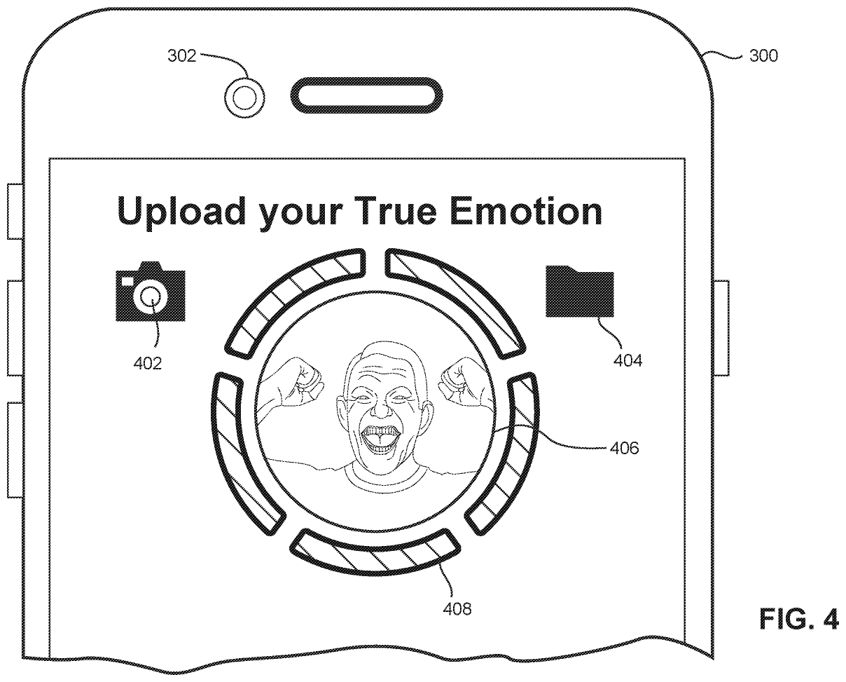

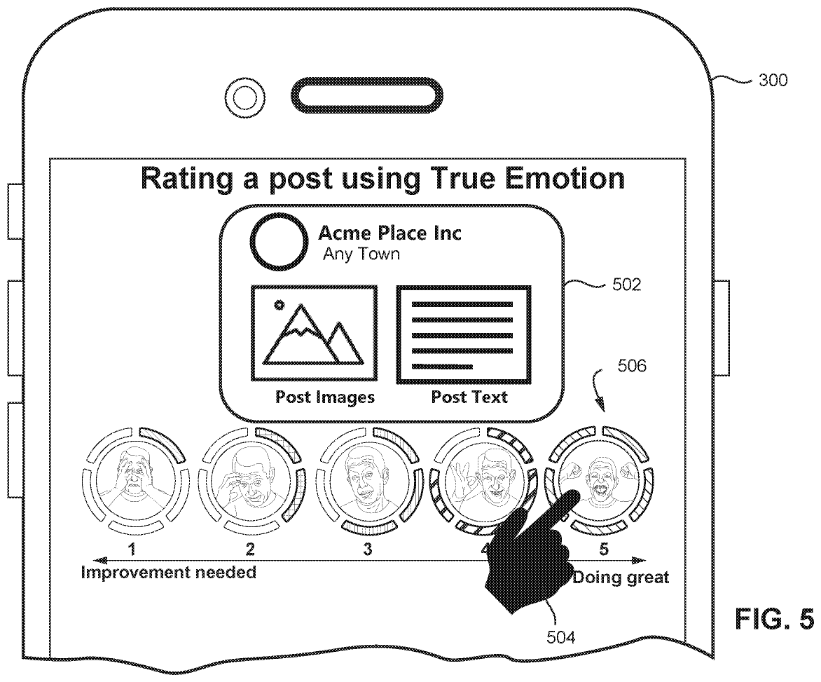

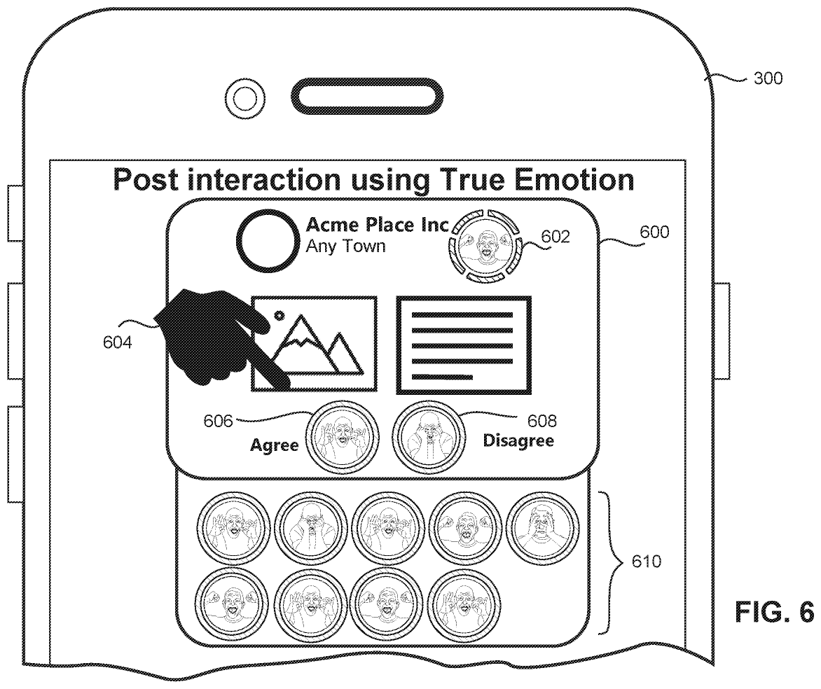

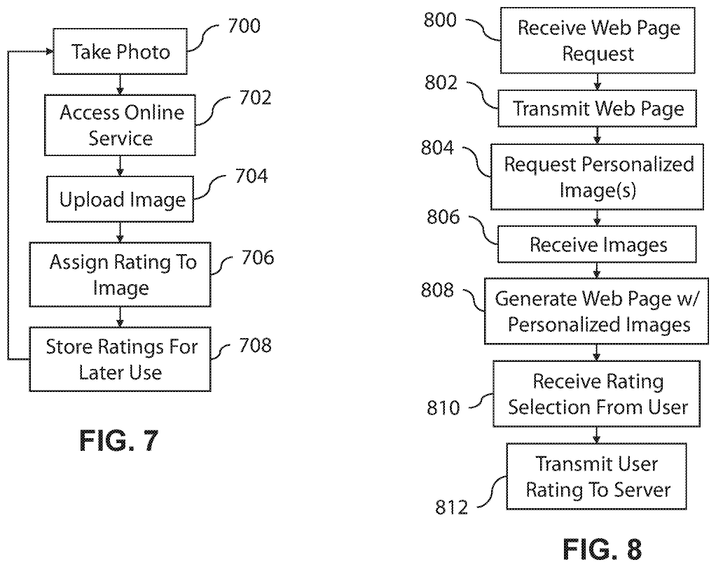

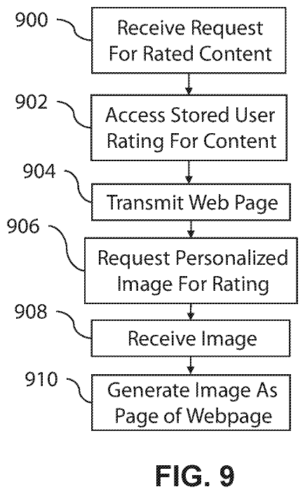

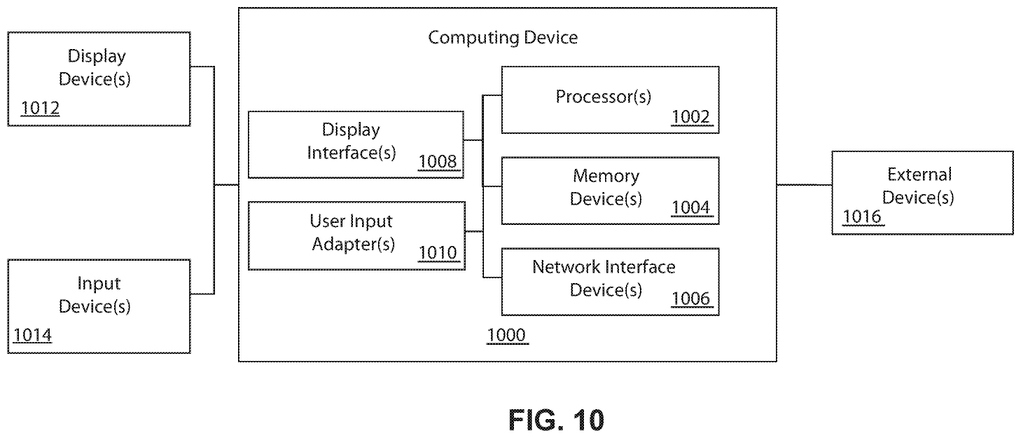

FIG. 1 is an architecture diagram of a system that allows users to provide personalized interactions with digital content according to certain example embodiments. FIGS. 2A and 2B are illustrative personalized images that can be used with the System shown in FIG. 1. FIGS. 3 and 4 illustrate GUIs for setting up personalized images to be used within the system shown in FIG. 1. FIGS. 5 and 6 illustrate different GUIs for interacting with digital content by using the system shown in FIG. 1. FIGS. 7-9 includes three flow charts that illustrate how a user can interact with the system shown in FIG. 1. FIG. 10 shows an example computing device that may be used in some embodiments to implement features described herein.

In many places in this document, including but not limited to in the above description of FIG. 1, software modules and actions performed by software modules are described. This is done for ease of description; it should be understood that, whenever it is described in this document that a software module performs any action, the action is in actuality performed by underlying hardware elements (such as a processor and a memory device) according to the instructions that comprise the software module. Further details regarding this are provided below in, among other places, the description of FIG. 10.

### Description of FIG. 1

FIG. 1 is an architecture diagram of a system 100 that allows users to provide personalized interactions with or for digital content according to certain example embodiments.

System 100 includes computer systems 104a and 104b used by respective users to communicate, via electronic network 102 (e.g., the Internet), with server(s) 108 and/or server(s) 106.

In certain example embodiments, users use their respective computer systems 104a and 104b to communicate with server(s) 106 to setup their personalized interactions. Personalized interactions may include images, such as images that represent the emotion of the user (e.g., their true emotion) that is supplying the feedback/input/rating to the digital content. In certain examples, users may also create, browse, or interact with digital content that is provided by server(s) 106 or 108. Such interaction may include using their respective personalized interactions to create or interact with digital content. Users may generate posts or other content for server(s) 106 and/or 108 that are then made available to other users for digital consumption (e.g., similar to a post on Facebook, a blog post, etc.).

For example, a user of computing system 104a may create a post, assign their true emotion image to that post (e.g., digital content) and then transmit the post (along with the true emotion image) to server 106. The generated post may reference or refer to a business that runs a website hosted by server 108. Another user, via computing system 104b, may then read or otherwise interact with the created posting. Such interactions may include assigning or giving their own true emotion image for the post, which may also be stored on server 106.

Computer systems 104a and 104b that are used by users may be mobile computing devices (e.g., an iPhone or Android-based mobile phone), a tablet, laptop, desktop computer, game console, or other type of computing device that is used to electronically communicate with server(s) 106 and/or 108. An example of computer systems 104a and 104b includes the computing device as shown in FIG. 10.

Network 102 may include the Internet (or other publically accessible network) or other types of electronic networks. In certain example embodiments, network 102 may be privately controlled (e.g., a corporate network or a network at a university) and servers 106 and/or 108 may be controlled by the organization that controls the network 102.

Server(s) 106 are computer systems that host data related to the images that are uploaded by users and associated with a rating or score. For example, server(s) 106 may host data that stores the images and ratings shown in FIGS. 2A and 2B. Server(s) may receive image uploads as described in FIGS. 3 and 4. Server(s) may store post information and other digital content that is associated with the images as shown in FIGS. 5 and 6. In certain example embodiments, server(s) 106 may be provided on a cloud-based computing environment (e.g., Amazon AWS, Microsoft Azure, etc.). In certain examples, the processing performed by servers(s) 106 may be performed in virtual machines or virtual containers (e.g., Docker, Kubernetes, or the like). In certain example embodiments, computing device 1000 shown in FIG. 10 may be used to implement server(s) 106.

In certain example embodiments, server(s) 108 may be a computer system that hosts a website that relates to a post (or other digital content) stored on server 106. For example, a post (e.g., a review of business) that is stored on server 106 may relate to a place of business that has a website hosted on server(s) 108. In certain example embodiments, server(s) 108 may host digital content that is accessible to users of computer systems 104a and/or 104b. In certain example embodiments, server(s) 108 may also access or communicate with server(s) 106 to make available or integrate the data that is stored on server(s) 106. For example, and as explained in greater detail below, the personalized images (e.g., true emotion images of users) stored on server(s) 106 may be provided for use as part of a website or other digital service that is hosted on server(s) 108. In certain example embodiments, computing device 1000 shown in FIG. 10 may be used to implement server(s) 108.

In certain example embodiments, an electronic service may be hosted by server(s) 106. The service may be a social media type service that allows users to post content that is stored with server(s) 106. The posts may be created using computing system 104a of the user. The post may be, for example, a review of a product or a business. The posts may include a personal emotional image (e.g., the true emotion image for that user) that has been assigned a rating (e.g., on a scale of 1 to 5, with 1 being the worst and 5 being the best). The post (or data that is used to generate a post) may then be transmitted from computing system 104a, via network 102, to computing system 106 for processing thereon. The data regarding the post and the rating given by the user and/or the personal emotional image may be stored on non-transitory storage of computing system 106 for later use. The later use may include providing the post and/or assigned image to computing system 104b for viewing by another user.

In certain example embodiments, the digital content and its rating may be provided as part of a public electronic data feed to other computing systems. The digital content (e.g., the post) that is generated by the user may be made socially available to other users (e.g., those part of the service that is hosted on computer system 106) to view and interact with on a mobile device (or other computing system). This can allow other users to respond to the content and/or the rating that the original user assigned to the digital content. In certain example embodiments, interactions with created posts may be provided in a binary form (e.g. agree/disagree). This allows other users to ‘dislike or vote against’ or ‘like or vote for’ the created post (and/or its associated rating). Examples of this aspect are discussed in connection with FIG. 6.

In certain example embodiments, others may interact with the post in both private and public ways. For example, if the original post is a review regarding a place of business, then that business (e.g. via another computer system, such as server 108) may respond privately to the original user regarding the content of the original post.

In certain example embodiments, a user may (e.g., using computing system 104a) setup 5 different images that are each assigned a rating from 1 to 5 (other scales may also be used). These images and their assigned ratings may be transmitted to server(s) 106. The user can then interact with a website hosted by server 108 to assign their personal images to digital content of the website. For example, to provide a review of a business or organization or make a comment on a website (e.g., of a news article or a forum posting). The review or feedback may include uploading or assigning one of user's personalized images to the digital content that the user is interacting with. For example, instead of giving a rating of “5” to the business, the user may instead assign one of their own personal emotional image as the “score” for the review. As another example, a user may assign their personal image (e.g., 202C as shown in FIG. 2A) to a comment or new article that they are reading to express their emotional reaction to that digital content. The rating that is associated with the provided emotional image may then be processed by the server(s) 108 and/or 106 to, for example, subsequently determine an average rating for the digital content. This average may be displayed on the website.

### Description of FIGS. 2A-2B

FIG. 2A illustrates different personalized images that can be specified by a user according to certain example embodiments. FIG. 2B illustrates a binary option for allowing a user to provide personalized images according to certain example embodiments.

The personalized images may be provided as part of a graphical user interface 200. Each of personalized user images (e.g., the true emotion of the user providing the images) 202A, 202B, 202C, 202D, and 202E include an image 204 that is provided by a user and a rating that is represented by a colored circle element 206 and/or number (e.g., 1-5 as shown in FIG. 2A). The images 204 may be static images or animated (e.g., animated GIFs). In certain example embodiments, video may be used (e.g., short video clips or the like). The images may be used to represent the emotion of the user from a negative emotion or reaction (e.g., 202A, representing a response that “improvement is needed” or really mad) to a positive emotion (e.g., 202E, representing a response of “doing great” or very happy).

Circles may be provided around the images and change color with each image. For example, red may be used for 202A, orange for 202B, yellow for 202C, green for 202D, and blue for the 202E. The circles may be complete or segmented (e.g., as shown in FIG. 2A). For example, only one part of a circle may be filled in as shown in 202A, whereas all parts of the circle in 202E are filled in. The increasing number of segments may correspond to an increase in emotional state (e.g., sad vs happy). Thus, the user interface may provide different visual indications in order to differentiate between each of the different images in the GUI 200. In general, the visual cues provided in GUI 200 may visually represent different emotions on an indicated scale (e.g., 1-5). Accordingly, in FIG. 2A, 202B may represent being less angry than 202A, while 202C may be neutral, with 202D being happy, but not quite as delighted as 202E.

In the example shown in FIG. 2A, the user has uploaded five different images and assigned them to separate ratings that represent their own personal emotions. The images may be personal to the user (e.g., selfies) or other images that may or may not include the user (or the user's likeness, such as an artistic illustration of the user or an image of something else entirely, like a rainbow or a dog). Each of the photos are then aligned with provided scores based on user input. In other words, the user decides which photos will represent a rating of “1”, which will represent a “5” rating (out of 5), and which photos will represent the in between ratings. It will be appreciated that other scales may be used (e.g., 1 to 3, 1 to 10, 1 to 100, etc.) Thus, a user may upload or otherwise provide a different number of photos depending on specific types of implementations.

In certain example embodiments, ratings may not be expressly shown. Instead, a user may be arrange multiple photos or images from worst to best and then the service may automatically determine a rating for each photo (e.g. based on the number of photos). Thus, for example, if a user provides 7 photos, arranged from worst to best, then the service (e.g., provided on server 106) can assign ratings to those 7 photos depending on the rating scheme that is used. If a rating scheme is binary (yes/no), then the two extremes could be used as the representative photos. If the rating scheme is 1 to 10 and the 7 photos are provided, then some of the photos could be used for two different rating (e.g., one photo could be used for both a rating of 7 and 8). Accordingly, in some examples, the number of photos may match the number of possible ratings and in other examples, the number of photos and the number of ratings may be different. This type of implementation may allow for the same photos to be used in connection with different scales (e.g., one implementation may use a scale of 1 to 4, while another may use a scale of 1 to 5, and another may just have a binary scale).

FIG. 2B illustrates a binary option for allowing a user to provide personalized interactions according to certain example embodiments. Just as the personalized interactions can be used to rate or score digital content (or physical content that is being rated in digital form), the system can also be used to like/dislike or vote for/against a positing or other content. FIG. 2B provides such an example with personalized interactions 250 and 260. Each of these personalized interactions includes, respectively, images 254 and 264, that are provided by a user and assigned to the like/dislike or and agree/disagree state. The personalized interactions are also highlighted with different colors 252 and 262 around the provided images. Thus, for example, a blue highlight 252 (indicating agreement or the like) may encircle image 254. Similarly, a red highlight 262 (indicating disagreement or the like) may encircle image 264. Each of the personalized interactions may then be provided to the user to allow them to react to posts or other digital content.

The elements shown in FIGS. 2A and 2B may both be provided by the same system (e.g., servers 106) and/or may be provided independently of each other. Thus, for example, a user may setup images for the scale system shown in FIG. 2A and also setup images for the binary choice shown in FIG. 2B. Then the personalized user images for each of these may be used as discussed above.

### Description of FIGS. 3-4

FIG. 3 shows an example graphical user interface for adding personalized content according to certain example embodiments. The graphical user interface shown in FIG. 3 is provided on display screen 304 of a mobile phone 300. Mobile phone 300 is an example of computing systems 104a and 104b.

Mobile phone 300 includes camera 302 and is configured to acquire images that can be used in connection the GUI that is provided on the display screen 304. An example of display screen 304 includes display device(s) 1012. Display screen 304 may also be provided in correspondence with a touch screen (e.g., as described in connection with input device(s) 1014). In certain example embodiments, users may provide input to a system by using a touch screen. In certain example embodiments, and as discussed in connection with FIG. 10 and user input adapters 1010, users may provide input via gesture controls or via voice commands or the like. Accordingly, the techniques here may use different input technologies to allow users to provide input to the system and, for example, select, personalized interactions or the like.

The display screen shown on mobile phone 300 may be part of an “app”, a website, or other service. Thus the GUI that is shown in FIG. 3 may be generated/stored locally on mobile phone 300 (e.g., as part of locally installed “app”) or may be provided via a website (and then displayed in a browser).

As shown in FIG. 3, the user is prompted to create/upload 5 separate personalized user images. As noted herein the GUI may be designed to require a different number of images. The images may be acquired via camera 302 or may be loaded from memory of mobile phone 300. In certain examples, the images may be stored on a cloud storage service and accessed for use with the service shown in FIG. 3.

When a user creates or uploads their image(s) (e.g., to server(s) 106), the receiving service will then associate the images to the rating provided by the user and store the images and associated ratings for later use (e.g., to a database or the like). The example shown in FIG. 3 has a rating from 1 to 5, with 1 being the worst and 5 being the best. Accordingly, the images that are specified by the user for each of the personalized user images 310, 312, 314, 316, and 318 will be associated with their corresponding rating.

In the example shown in FIG. 3, the user has specified images for each of 310, 312, 314, and 316 and is now deciding which image to use for personalized image 318—for the rating number 5 (e.g., very happy, doing great). To add the image the user may click or indicate onto the generic/default icon shown in 318. In response to this indication, the GUI shown in FIG. 4 may be displayed.

FIG. 4 shows an example graphical user interface for allowing users to add images to the interface shown in FIG. 3. Continuing with the example discussed above, once the user has chosen to add an image to 318, then the GUI shown in FIG. 4 is displayed. The GUI includes an area that is used to display a selected image and the circle highlight 408 that is the same as that of the rating selected from FIG. 3. Thus, for example, if the user selects 310 in FIG. 3, then the highlight 408 may match the highlight for the image shown in FIG. 3.

Also present in the GUI shown in FIG. 3 are two options for uploading or selecting images. The first is to use the camera 302 by selecting icon 402. Selecting icon 402 may cause the camera of the mobile phone to activate and take a selfie of the user in question. The second option is to select an already taken/created image by pressing icon 404. This will allow the user to select a previously taken image that is stored locally or to navigate to another image that may be found, for example, by browsing the web or accessing cloud-storage of photos for the user. In either case, a photo may be selected and added as image 406. Image 406 will then be used for personalized image 318 in FIG. 3.

In certain example embodiments, selection of each image in FIG. 3 may cause the mobile phone 300 to communicate with server(s) 106 to save the selected photo and its relationship to a given rating. In other example embodiments, the mobile phone 300 may wait until all images and/or ratings have been assigned before communicating with server(s) 106.

It will be appreciated that while certain examples discussed herein are provided in the context of a mobile device (e.g., smart phone 300), that the techniques may also be used in connection with other types of computing devices (e.g., laptops, game consoles, desktop computers, tablets, etc.).

In certain example embodiments, the techniques herein may be used in virtual reality (VR) or augmented reality (AR) implementations. For example, the content displayed to a user (e.g., any or all of the GUIs or other graphical elements discussed herein) may be presented to a user in a VR headset that the user is wearing. An illustrative example of a VR headset is the Oculus Rift.

In certain example embodiments, the techniques herein may also be applied to AR implementations. For example, a AR implementation may include having a heads-up display in AR glasses that allows a user to provide personalized interactions to objects, places, people, etc. that are recognized within the view of the glasses. For example, a person may view a car through their AR-enabled glasses and then provide a personalized interaction in connection with recognition of that car. The provided personalized interaction may then be communicated to server(s) 106 or the like for storage (or stored locally). As an example, a GUI that is presented to the user through the glasses may include the personalized interactions available for selection (if no selection has been made) or the personalized interaction selected by the user. These may be presented to overlay or next to the where the object in question is located within the “view” of the real world presented to the person through the AR-enabled glasses.

Accordingly, it will be appreciated that the techniques herein may be implemented in connection with different types of computing systems and displays.

### Description of FIGS. 5-6

In certain example embodiments, after creating the personalized images and assigning ratings, users can then use the personalized images in connection with providing a rating or score for content. The content may be a post created by a user regarding a business (e.g., a restaurant or hotel) or may be for a website or product. The digital content may be other posts or articles (e.g., newspaper articles or the like). The digital content may be provided in connection with sporting events or other types of events (e.g., to rate plays or players in a sporting event).

FIG. 5 shows an example graphical user interface that allows users to use their personalized images in connection with creating posts and providing ratings, via the images, according to certain example embodiments. Here, a user 504 creates a post 502 that is a review of “Acme Place Inc.” located in Any Town. The post the user creates can include text and/or images. The user may then assign a rating by using one of the user's personalized images that have been setup (e.g., as discussed in connection with FIG. 3). In the FIG. 5 example, the user 506 is happy with the experience at Acme Place and provides input to the mobile phone 300 to select personalized interaction 506 that includes the personalized image. Personalized interaction 506 has been given a rating of 5 to represent that the user is ‘very happy’ or the place is ‘doing great’.

Once the post is created it may be submitted to server 106 for processing. This may include storing the post and the data regarding the rating by the user and providing the post to other users for consumption via a social or public feed. For example, via an RSS fee or the like or via a forum or social network.

In certain examples, the rating and the scale shown at the bottom of the GUI in FIG. 5 may be hidden and only the images may be displayed. In certain examples, the highlighted colors around the images may be displayed (without or without the scale also being displayed).

FIG. 6 shows another example graphical user interface that allows users to use their personalized interactions to rate digital content according to certain example embodiments. In FIG. 6, the post 502 that was created in FIG. 5 with the personal interaction 506 (e.g., that the user rated acme place by using personal interaction 506) is shown as post 600. Post 600 includes the person interaction 602 that was provided by user 504 in FIG. 5.

For already created posts, like post 502 after creation, users can rate or agree/disagree with the created post. In FIG. 6, user 604 has the option to agree 606 or disagree 608 with the original post created by user 504. The agree 606 and disagree 608 options are based on personalized interactions (e.g., images) that have defined by user 604 (e.g., as described in connection with FIG. 4). In FIG. 6, user 604 selects the emotional interaction that agrees with the post 600 (e.g., that user 604 also thinks Acme Place Inc is good, or that the review was helpful).

Also included in the display of post 600 is a group of other interactions 610 that show how other users (e.g., beyond user 604) have reacted to post 600. These may be displayed concurrently with the post 600 and/or the agree/disagree options thereof.

In certain example embodiments, post 600 may also include a visual indication of an average or overall rating for Acme Place Inc. For example, the circle around the logo for the business may change color or increase/decrease in size. In certain examples, additional portions of the circle may be completed based on the rating (e.g. a full circle being a 5/5 rating and a 80% completed circle being an average 4 out of 5 rating).

### Description of FIGS. 7-9

FIGS. 7-9 show three flow charts of processing that may be performed using the system shown in FIG. 1.

In FIG. 7, a process of assigning ratings to images is shown. This may be performed in connection with the description provided in FIGS. 3 and 4.

At 700, a user takes a photo of themselves (e.g., a selfie). This photo will be used to reflect an emotion of the user and is thus personalized to them in how they interact with (e.g., rate or provide feedback for) digital content. While a selfie is used in this example, in other examples, different types of images may be used. For example, an illustration or an image that doesn't include the user may be used. For example, a picture of a sunset may represent calm or happy. Or a picture of the user's dog may represent a high rating (e.g., indicating happiness). In general, the picture that is selected by the user will be personal to that user (e.g., it may be unique amongst all other photos that are stored by server(s) 106). In certain example embodiments, the collective group of images selected by each user (their personalized images) may be unique to that corresponding user (e.g., even if one or more images are unique amongst all other images stored in system 100)

In certain examples, users may use default or stock photos or icons. For example, a common frown or sad face emoji could be used to represent a rating of 1. Other types of stock or default photos may be used by users in certain instances. Such default or stock image may be used in combination with personalized images that are unique (or nearly so) to that user. Upon creating an account with the service hosted on server(s) 106, default images may be used. User may then replace the default images with personalized ones. In any event, a photo is acquired at 700.

At 702, the user then accesses an online service that stores data for the personalized images and associated ratings. This may include logging into a service that is provided via servers 106.

At 704, the image selected by the user is then uploaded to the service and stored thereon.

At 706, the user assigns a rating to the image. The rating may be one rating on a scale of possible ratings (e.g., between 1 and 10). The ratings may be defined by the user or may be provided relative to other images (e.g., one image being more positive than another, but not assigned an explicit rating). Thus, the rating may be relative to other images or may be absolute (e.g., “4”).

At 708, the ratings and the images associated with such ratings are stored to memory for later use.

Turning now to FIG. 8, a process that may be used in connection with the system shown in FIG. 1 is provided. In this example, the posts or content being rated are provided separately from the ratings and the personalized images. For example, server(s) 108 may host a website that allows users to comment on or rate items on that website (e.g., articles, reviews of hotels, product reviews, etc. . . . ). The website hosted by server(s) 108 may allow for users to use their personalized ratings and images (hosted by server(s) 106) when rating content on the website. In certain example embodiments, the personalized interactions (e.g., images) may be used in combination with other rating systems that do not use personalized interactions (e.g. images). Thus, a website hosted by server(s) 108 may provide enhanced or more personalized functionality to their users by implementing the personalized interactions that are provided by the service from server(s) 106.

At 800, a user transmits a request for a webpage and this is received at server(s) 108. The request may be, for example, for a news article and the user will be providing feedback or a rating for the article.

At 802, server(s) 108 provide the web page content to the user's device (e.g., computing system 104a). This may be, for example, a response to an http request made from the user's device.

At 804, the requested web page is processed by the user's device (e.g., it is being rendered by a browser) and as part of this process, a request is initiated to server(s) 106 for personalized images associated with the user that made the request.

At 806, the personalized interactions (e.g., images) are communicated, from server(s) 106, to the user's device and the rendering process continues with the generation of the webpage at 808. The generation of the webpage may include incorporating the personalized images into the webpage content provided from server(s) 108. Thus, as an example, the post 502 may be retrieved from server(s) 108 (e.g., as a news article) and the personalized images that the user will use to provide feedback will be retrieved from servers 106. The data from both of these requests will be used to form the web page (or other graphical user interface display) that is then presented to the user. An example may be similar to that shown in FIG. 5.

At 810, the user provides feedback to their device to select a rating for the news article that is being displayed on the user's device. Such a selection may be similar to that shown in FIG. 5 when user interaction 506 is selected by a user.

At 812, the rating selection may be transmitted back to server(s) 108 where the rating that was selected by the user may then be stored and used by the operators of the website (e.g., to incorporate into an aggregate rating or to display as discussed in connection with the process shown in FIG. 9). In certain examples, only the raw rating (e.g., “5”) that is associated with the personalized image may be transmitted back to server(s) 108. In other words, the website that is hosted by server(s) 108 may not need to store or manage the personalized interaction and their associated ratings, but instead may incorporate code to provide functionality that is then handled by server(s) 106.

In certain examples, data for rating of the news article may also be transmitted to server(s) 106, which may store that a news article was rated by the user (and the rating given to that article). This information may then be presented to the user in aggregate form later—potentially aggregating ratings given to many different articles or digital content from different websites. The presentation of such an aggregation may include the personalized images created by the user.

Turning now to FIG. 9, a process for displaying a previously provided rating of an article or other piece of digital content is shown.

At 900, the user's computing device transmits a request for content that the user has already rated and this request is received by server(s) 108 that host the content. Post 600 may be an illustrative example of a post or digital content that is being requested.

At 902, as part of processing the request for the content, server(s) determine that the user requesting the website has provided a rating for the requested content. This data is collected and provided as part of the response that is transmitted at 904 (e.g., the article is communicated along with the rating the user provided that article).

The user's device receives the response at 906 and then, as part of rendering the web page (or other display), transmits a request, to server(s) 106, for the personalized image for that user that is associated with the rating provided by server(s) 108. Thus, for example, if the user previously gave the requested article a 5 out of 5 rating, then the request may be a request to server(s) 106 for the personalized image that is associated with the 5/5 rating.

The request is received by server(s) 106, which then selects the appropriate image and returns it to the user's device at 908.

At 910, the web page rendering process continues with displaying the now received personalized image along with the requested article. As noted above, an illustrative example may be an article like post 600 from FIG. 6 and the personalized image may be 602.

A similar process may also be performed for articles (or other digital content) that have been rated by other users, but not the requested user. For example, when the article is provided to the user's computing device, it may be associated with a list of <rating, User ID> tuples. This listing may then be used to request, from server(s) 106, the specific personalized images for each user that has already given a rating. The rendered web page may then incorporate this data in how the web page is displayed to the user on the user's device. An example of this may be similar to how the personalized images 610 are displayed in FIG. 6, where each of those images relates to different users that have already provided feedback for an article (e.g., 600).

It will be appreciated that while some of the examples discussed herein reference web pages, similar functionality may also be used for non-web page applications (e.g., mobile phone “apps” or computer applications).

In certain example embodiments, the personalized images may be stored locally on the computer system used by the user and the relationship to the ratings may be stored locally as well. In such instances, the images may be accessed when digital content is being rendered on that device that includes a rating made by that user.

### Description of FIG. 10

FIG. 10 is a block diagram of an example computing device 1000 (which may also be referred to, for example, as a “computer device,” “computer system,” or “computing system”) according to some embodiments. In some embodiments, the computing device 1000 includes one or more of the following: one or more processors 1002 (also called hardware processors herein); one or more memory devices 1004; one or more network interface devices 1006; one or more display interfaces 1008; and one or more user input adapters 1010. Additionally, in some embodiments, the computing device 1000 is connected to or include display device(s) 1012. Additionally, in some embodiments, the computing device 1000 is connected to or includes one or more input devices 1014. In some embodiments, computing device 1000 may be connected to one or more external devices 1016. As will be explained below, these elements (e.g., the processors 1002, memory devices 1004, network interface devices 1006, display interfaces 1008, user input adapters 1010, display device 1012, input devices 1014, external devices 1016) are hardware devices (for example, electronic circuits or combinations of circuits) that are configured to perform various different functions for and/or in conjunction with the computing device 1000.

In some embodiments, each or any of the processors 1002 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes, for example, a CPU, a GPU, and other hardware components such as memory and/or a memory controller (e.g., Northbridge), I/O controller (e.g., Southbridge), networking interfaces, and the like). In some embodiments, each or any of the processors 1002 uses an instruction set architecture such as x86 or Advanced RISC Machine (ARM). In some embodiments, each or any of the processors 1002 is or includes, for example, a graphical processing unit (GPU), which may be an electronic circuit designed to generate images and the like.

In some embodiments, each or any of the memory devices 1004 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions that may be executed by one or more of the processors 1002), or other type of device that performs the volatile or non-volatile storage of data and/or instructions (e.g., software that is executed on or by processors 1002). In some embodiments, each or any of the memory devices 1004 is removable from the computing device 1000 (such as a USB flash drive, a floppy disk, a Compact disc (CD), and the like). Memory devices 1004 are an example of non-transitory computer-readable storage.

In some embodiments, each or any of the network interface devices 1006 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces 1008 is or includes one or more circuits that receive data from the processors 1002, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 1012, which displays the image data. Alternatively or additionally, in some embodiments, each or any of the display interfaces 1008 is or includes, for example, a video card, video adapter, or graphics processing unit (GPU). In other words, the each or any of the display interfaces 1008 may include a processor therein that is used to generate image data. The generation or such images may occur in conjunction with processing performed by one or more of the processors 1002.

In some embodiments, each or any of the user input adapters 1010 is or includes one or more circuits that receive and process user input data from one or more user input devices (1014) that are included in, attached to, or otherwise in communication with the computing device 1000, and that output data based on the received input data to the processors 1002. Alternatively or additionally, in some embodiments each or any of the user input adapters 1010 is or includes, for example, a PS/2 interface, a USB interface, a touchscreen controller, or the like; and/or the user input adapters 1010 facilitates input from user input devices 1014.

In some embodiments, the display device 1012 may be a Liquid Crystal Display (LCD) display, Light Emitting Diode (LED) display, or other type of display device. In embodiments where the display device 1012 is a component of the computing device 1000 (e.g., the computing device and the display device are included in a unified housing), the display device 1012 may be a touchscreen display or non-touchscreen display. In embodiments where the display device 1012 is connected to the computing device 1000 (e.g., is external to the computing device 1000 and communicates with the computing device 1000 via a wire and/or via wireless communication technology), the display device 1012 is, for example, an external monitor, projector, television, display screen, etc. . . .

In some embodiments, each or any of the input devices 1014 is or includes machinery and/or electronics that generates a signal that is provided to the user input adapter(s) 1010 in response to physical phenomenon. Examples of inputs devices 1014 include, for example, a keyboard, a mouse, a trackpad, a touchscreen, a button, a joystick, a sensor (e.g., an acceleration sensor, a gyro sensor, a temperature sensor, a pressure sensor (e.g., that measures pressure of a gas), a flow sensor (e.g., the measures a rate of gas or liquid flow), and the like), a microphone. In some examples, one or more input devices 1014 generate signals that are provided in response to a user providing an input—for example, by pressing a button, speaking a voice command, or the like. In other examples, one or more input devices generate signals based on sensed physical quantities (e.g., such as force, pressure, temperature, etc.). In some embodiments, each or any of the input devices 1014 is a component of the computing device (for example, a button is provide on a housing that includes the processors 1002, memory devices 1004, network interface devices 1006, display interfaces 1008, user input adapters 1010, and the like).

In some embodiments, each or any of the external device(s) 1016 may include other computing devices (e.g., other instances of computing device 1000) that communicate with computing device 1000. Examples may include a server computer, a client computer system, a mobile computing device, a cloud-based computer system, a computing node, an Internet of Things (IoT) device, a flow generator, etc. that all may communicate with computing device 1000. In general, external devices(s) 1016 may include devices that communicate (e.g., electronically) with computing device 1000. As an example, computing device 1000 may be mobile device communicates with a flow generator or a patient interface device or mask (e.g., examples of external device 1016). Conversely, computing device 1000 may be a flow generator that communicates with server or cloud-based computer system, which are examples of external devices 1016, that provides data and/or software updates to the flow generator.

In various embodiments, the computing device 1000 includes one, or two, or three, four, or more of each or any of the above-mentioned elements (e.g., the processor(s) 1002, memory device(s) 1004, network interface device(s) 1006, display interface(s) 1008, user input adapter(s) 1010, display device(s) 1012, input device(s) 1014). Alternatively or additionally, in some embodiments, the computing device 1000 includes one or more of: a processing system that includes the processors 1002; a memory or storage system that includes the memory devices 1004; and a network interface system that includes the network interface devices 1006.

The computing device 1000 may be arranged, in various embodiments, in many different ways. As just one example, the computing device 1000 may be arranged such that the processors 1002 include: a multi (or single)-core processor; a first network interface device (which implements, for example, WiFi, Bluetooth, NFC, etc.); a second network interface device that implements one or more cellular communication technologies (e.g., 3G, 4G LTE, CDMA, etc.); memory or storage devices (e.g., RAM, flash memory, or a hard disk). The processor, the first network interface device, the second network interface device, and the memory devices may be integrated as part of the same SOC (e.g., one integrated circuit chip). As another example, the computing device 1000 may be arranged such that: the processors 1002 include two, three, four, five, or more multi-core processors; the network interface devices 1006 include a first network interface device that implements Ethernet and a second network interface device that implements WiFi and/or Bluetooth; and the memory devices 1004 include a RAM and a flash memory or hard disk. As another example, the computing device 1000 may include a SoC with one or processors 1002, plural network interface devices 1006 (e.g., one that uses communicates via a Cellular connection and one that communicates via a Bluetooth connection), memory devices 1004 that include system memory and memory for application programs and other software, a display interface 1008 that is configured to output a video signal, a display device 1012 that is integrated to a housing and layered with a touch screen input device 1014, and multiple input device 1014 such as one or more buttons and/or and one or more sensors.

The hardware configurations shown in FIG. 10 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 10, (e) via other hardware arrangements, architectures, and configurations, and/or via combinations of the technology described in (a) through (e).

### Technical Advantages of Described Subject Matter

In certain example embodiments, an improved user interface is provided that allows for users to more personally express themselves when rating or providing feedback in a digital environment. Rather than providing a generic rating (e.g., 5), the user provides a personalized interaction, which may be in the form of an image or the like. In certain example embodiments, users can use their personalized interactions to provide binary feedback, such as agreeing/disagreeing, voting yes/no, or the like.

The techniques herein also allow for greater flexibility in how online rating/feedback/scoring systems may be used by providing users the ability to express their own personal style or emotions in connection with such interaction. The techniques herein may be applied in social network settings to increase the level of personalization that each user has with various forms of digital content. The techniques herein thus provide for improved interfaces and techniques for engagement by users with digital content.

### Selected Terminology

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

### Additional Applications of Described Subject Matter

Although process steps, algorithms or the like, including without limitation with reference to [Figures X-Y], may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A computer system comprising:
non-transitory computer readable storage;
a processing system that includes at least one hardware processor, the processing system configured to:
receive, for each corresponding user of a plurality of users, a plurality of personalized images that have been provided by each corresponding user;
receive, from each corresponding user, assignment of a different number to each one of the plurality of personalized images for each corresponding user;
store, to the non-transitory computer readable storage, the plurality of personalized images for each corresponding user and the assigned number for each one of the plurality of images, wherein each corresponding user has a different set of personalized images;
cause digital content to be presented on computing devices associated with each one of the plurality of users, wherein the digital content includes a first personalized image provided by a first user, wherein the digital content presented on each computing device is displayed concurrently with: 1) the plurality of personalized images that are associated with the corresponding user of the computing device, and 2) one of the plurality of personalized images from each of a plurality of other users that have provided feedback on the digital content;
receive, from each one of the computing devices, a user selection that indicates one of the plurality of images that are displayed concurrently with the presented digital content; and
store, to the non-transitory computer readable storage, data that links the user selection that indicates one of the plurality of personalized images to the digital content that was presented.

2. The computer system of claim 1, wherein the processing system is further configured to:
calculate, based on all of the data that links an image to the digital content, a calculated value for the digital content.

3. The computer system of claim 2, wherein the calculated value is an average of values assigned to each personalized image that is linked to the digital content.

4. The computer system of claim 1, wherein the processing system is further configured to:
in response to a request for the digital content, retrieve each personalized image that has been linked to the digital content; and
communicate, to a requesting computing device, the digital content along with each personalized image that has been linked to the digital content to thereby be displayed concurrently with the digital content.

5. The computer system of claim 1, further comprising:
the computing devices, each one of the computing devices including a camera configured to acquire at least one image that is usable as one of the plurality of personalized images that are transmitted to the processing system.

6. The computer system of claim 1, wherein the processing system is further configured to:
receive, from a first computing device, a request for one of the plurality of personalized images, the request including a user identifier and the number that is assigned to one of the plurality of personalized images; and
communicate, to the first computing device, one of the plurality of personalized images that corresponds to the number for the user that is also associated with the user identifier.

7. A non-transitory computer-readable storage medium storing instructions for use with a computer system that includes at least one hardware processor, the stored instructions causing the computer system to perform operations comprising:
processing, for each corresponding user of a plurality of users, a plurality of personalized images that have been communicated from a computing device associated with each corresponding user;
storing, based on input provided from each computing device used by a corresponding user, assignment of a different number to each one of the plurality of personalized images for each corresponding user;
storing, to the non-transitory computer readable storage, the plurality of personalized images for each corresponding user and the assigned number for each one of the plurality of personalized images, wherein each corresponding user has a different set of personalized images;
causing digital content to be presented on computing devices associated with each one of the plurality of users, wherein the digital content presented on each computing device is displayed concurrently with the plurality of personalized images that are associated with the corresponding user of the computing device;
causing, on at least one of the computing devices that is associated with a corresponding one of the plurality of users, a visual element to be displayed outside of each of the plurality of currently displayed personalized images that are associated with the corresponding user, where each visual element that is displayed varies in a number of segment counts and/or color that is based on the number assigned to the corresponding one of the plurality of currently displayed personalized images; receiving, from each one of the computing devices, a user selection that indicates one of the plurality of personalized images that are displayed concurrently with the presented digital content; and
storing, to the non-transitory computer readable storage, data that links the user selection that indicates one of the plurality of personalized images to the digital content that was presented.

8. The non-transitory computer-readable storage medium of claim 7, the operations further comprising:
calculating, based on data that links all of the images to the digital content, a calculated value for the digital content.

9. The non-transitory computer-readable storage medium of claim 8, wherein the calculated value is an average of values assigned to each image that is linked to the digital content.

10. The non-transitory computer-readable storage medium of claim 7, the operations further comprising:
in response to a request for the digital content, retrieve each personalized image that has been linked to the digital content; and
communicate, to a requesting computing device, the digital content along with each personalized image that has been linked to the digital content, wherein each personalized image that has been linked to the digital content is displayed along with the digital content.

11. The non-transitory computer-readable storage medium of claim 7, the operations further comprising:
receiving, from a first computing device, a request for one of the plurality of personalized images, the request including a user identifier and the number that is assigned to one of the plurality of personalized images associated with a user with the user identifier; and
communicating, to the first computing device, one of the plurality of personalized images that corresponds to the number for the user that is also associated with the user identifier.

12. A method of providing a user with personalized images to react to digital content, the method comprising:
receiving, for each corresponding user of a plurality of users, a plurality of personalized images that have been provided by each corresponding user;
receiving, from each corresponding user, assignment of a different number to each one of the plurality of personalized images;
storing, to the non-transitory computer readable storage, the plurality of personalized images for each corresponding user and the assigned number for each one of the plurality of personalized images;
causing digital content to be presented on computing devices associated with each one of the plurality of users, wherein the digital content presented on each computing device is displayed concurrently with the plurality of personalized images that are associated with the corresponding user of the computing device;
receiving, from each one of the computing devices, a user selection that indicates one of the plurality of personalized images that are displayed concurrently with the presented digital content; storing, to the non-transitory computer readable storage and for each received user selection, data that links the user selection that indicates one of the plurality of images to the digital content that was presented; and
calculating a calculated value based on aggregation, for the digital content that was presented, of all of the numbers that are assigned to images linked to the presented digital content,
wherein the digital content displayed on the computing devices incorporates the calculated value.

13. The method of claim 12, wherein the calculated value is an average of values assigned to each personalized image that is linked to the digital content.

14. The method of claim 12, further comprising:
in response to a request for the digital content, retrieving each personalized image that has been linked to the digital content; and
communicating, to a requesting computing device, the digital content along with each personalized image that has been linked to the digital content.

15. The method of claim 12, further comprising:
using a camera of at least one of the computing devices to acquire an image of the user as one of the plurality of personalized images.

16. The method of claim 12, further comprising:
receiving, from a first computing device, a request for one of the plurality of personalized images, the request including a user identifier and the number that is assigned to one of the plurality of personalized images; and
communicating, to the first computing device, one of the plurality of personalized images that corresponds to the number for the user that is also associated with the user identifier.

17. The method of claim 12, wherein each personalized image or each grouping of the plurality of personalized images are unique.

18. The computer system of claim 1, wherein the processing system is further configured to:
communicate, to a computing device that is associated with the first user, the plurality of personalized images that are associated with the first user;
receive, from the computing device that is associated with the first user, the first personalized image that has been selected, from among the plurality of personalized images that are associated with the first user, by the first user to be included with the digital content,
wherein a number of the currently displayed plurality of personalized images that are associated with the corresponding user of the computing device is less than a number of plurality of personalized images that are associated with the first user.

19. The non-transitory computer-readable storage medium of claim 7, wherein at least one visual segment outside one of the plurality of currently displayed personalized images surrounds the one of the plurality of currently displayed personalized images.
